(19) United States
(12) Patent Application Publication
(10) Pub. No.: US 2022/0322005 A1
(43) Pub. Date: Oct. 6, 2022

(54) AUDIO FEEDBACK DETECTION APPARATUS AND AUDIO FEEDBACK DETECTION METHOD

(71) Applicant: PANASONIC INTELLECTUAL PROPERTY MANAGEMENT CO., LTD., Osaka (JP)

(72) Inventors: Shinichi Takayama, Fukuoka (JP); Hiromasa Ohashi, Osaka (JP)

(73) Assignee: PANASONIC INTELLECTUAL PROPERTY MANAGEMENT CO., LTD., Osaka (JP)

(21) Appl. No.: 17/708,221

(22) Filed: Mar. 30, 2022

(30) Foreign Application Priority Data
Mar. 31, 2021 (JP) 2021-061316

(51) Int. Cl. H04R 3/04; G10L 21/0232; G10L 25/78

(52) U.S. Cl. CPC H04R 3/04; G10L 21/0232; G10L 25/78; G10L 2021/02163

(57) ABSTRACT

An audio feedback detection apparatus including: a first audio signal input unit configured to acquire a first audio signal collected by a microphone; a second audio signal input unit configured to acquire a second audio signal from an audio communication application to be output to a speaker; and an audio feedback determination unit configured to determine whether an audio feedback is present based on a correlation between a frequency characteristic of the first audio signal input to the audio communication application and a frequency characteristic of the second audio signal input to the speaker. One of the microphone and the speaker is located on a path in which the audio feedback occurs, and the other of the microphone and the speaker is located on a path in which the audio feedback does not occur.

### CROSS-REFERENCE TO RELATED APPLICATIONS

This application is based on and claims the benefit of priority of Japanese Patent Application No. 2021-061316 filed on Mar. 31, 2021, the entire contents of which are incorporated herein by reference.

### FIELD

The present disclosure relates to an audio feedback detection apparatus and an audio feedback detection method.

### BACKGROUND

JP-A-2004-023722 discloses an audio feedback suppression apparatus including: filter means for filtering an audio signal of at least one of an input side and an output side of signal path setting means for setting signal paths of a plurality of audio signals for each of the signal paths; input and output signal path combination selection means for selecting a combination of one or more input and output signal paths based on a comparison result between a frequency characteristic of the input side audio signal and a frequency characteristic of the output side audio signal; audio feedback detection means for detecting an audio feedback of the selected input and output signal path; filter information generation means for generating filter information on audio feedback suppression based on an audio feedback characteristic; and filter control means for controlling the filter means of the selected input and output signal path. The filter means suppresses the audio feedback occurring in the selected input and output signal path based on the filter information.

### SUMMARY

Here, in a web conference system, it is assumed to suppress an audio feedback that may occur when a plurality of PCs each including a microphone and a speaker are disposed at an own place and are connected to a partner's place. A configuration disclosed in JP-A-2004-023722 is limited to a case where a plurality of audio input terminals and a plurality of audio output terminals included in the signal path setting means in the audio feedback suppression apparatus are controlled in the same audio feedback suppression apparatus. Therefore, when each of the plurality of PCs arranged at the own place detects the audio feedback in the web conference system described above using the configuration disclosed in JP-A-2004-023722, one PC at the own place cannot acquire an audio signal that can be acquired by the microphone included in the other PC arranged at the same own place and an audio signal output from the speaker included in the other PC. Therefore, it is difficult to apply the configuration disclosed in JP-A-2004-023722 to the web conference system described above.

In addition, a method of performing audio feedback detection based on a frequency characteristic of the audio signal obtained by only one of the audio input terminal (that is, the microphone) and the audio output terminal (the speaker) included in the PC may be considered. However, in this method, the frequency characteristic extracted from the audio signal obtained by only one of the audio input terminal and the audio output terminals is affected by signal processing performed in a transmission path (for example, an application used in the web conference system) of the audio signal. Therefore, the audio feedback cannot be accurately detected, and it is difficult to suppress the occurrence of the audio feedback.

The present disclosure has been made in view of the above-described situations in the related art, and an object thereof is to provide an audio feedback detection apparatus and an audio feedback detection method that suppress occurrence of an audio feedback that may occur between an audio input and output apparatus and another audio input and output apparatus including a microphone and a speaker.

The present disclosure provides an audio feedback detection apparatus including: a communication unit configured to communicate with one or more other terminals via a network; a microphone configured to acquire a first audio signal based on an utterance of a talker; a speaker configured to output a second audio signal from the one or more other terminals, the second audio signal being received by the communication unit and processed by an audio communication application; and an audio signal processing unit configured to detect whether an audio feedback is present based on a correlation between a frequency characteristic of the first audio signal input to the audio communication application and a frequency characteristic of the second audio signal input to the speaker, wherein one of the microphone and the speaker is located on a path in which the audio feedback occurs, and the other of the microphone and the speaker is located on a path in which the audio feedback does not occur.

Further, the present disclosure provides an audio feedback detection apparatus including: a first audio signal input unit configured to acquire a first audio signal collected by a microphone; a second audio signal input unit configured to acquire a second audio signal from an audio communication application to be output to a speaker; and an audio feedback determination unit configured to determine whether an audio feedback is present based on a correlation between a frequency characteristic of the first audio signal input to the audio communication application and a frequency characteristic of the second audio signal input to the speaker, wherein one of the microphone and the speaker is located on a path in which the audio feedback occurs, and the other of the microphone and the speaker is located on a path in which the audio feedback does not occur.

The present disclosure provides an audio feedback detection method executed by a computer including a microphone and a speaker and capable of communicating with one or more other terminals via a network, the audio feedback detection method including: acquiring a first audio signal based on an utterance of a talker by the microphone; acquiring a second audio signal from the one or more other terminals processed by an audio communication application installed so as to be executable by the computer; and detecting whether an audio feedback is present based on a correlation between a frequency characteristic of the first audio signal input to the audio communication application and a frequency characteristic of the second audio signal input to the speaker, wherein one of the microphone and the speaker is located on a path in which an audio feedback occurs, and the other of the microphone and the speaker is located on a path in which the audio feedback does not occur.

Further, the present disclosure provides an audio feedback detection method including the steps of: acquiring a first audio signal collected by a microphone; acquiring a second audio signal from an audio communication application to be output to a speaker; and determining whether an audio feedback is present based on a correlation between a frequency characteristic of the first audio signal input to the audio communication application and a frequency characteristic of the second audio signal input to the speaker, wherein one of the microphone and the speaker is located on a path in which an audio feedback occurs, and the other of the microphone and the speaker is located on a path in which the audio feedback does not occur.

The present disclosure provides an audio feedback detection apparatus including: a microphone configured to acquire a first audio signal based on an utterance of a talker; a communication unit configured to communicate an audio signal obtained by processing the first audio signal by an audio communication application with one or more other terminals via a network; a speaker configured to output a second audio signal from the one or more other terminals received by the communication unit and processed by the audio communication application; and an audio signal processing unit configured to detect whether an audio feedback is present based on the first audio signal before being processed by the audio communication application.

Further, the present disclosure provides an audio feedback detection apparatus including: a first audio signal detection unit configured to acquire a first audio signal collected by a microphone; a second audio signal detection unit configured to acquire a second audio signal from an audio communication application to be output to a speaker; and an audio feedback determination unit configured to determine whether audio feedback is present based on the first audio signal which has not been processed by the audio communication application.

The present disclosure provides an audio feedback detection method executed by a computer including a microphone and a speaker and capable of communicating with one or more other terminals via a network, the method including: acquiring a first audio signal based on an utterance of a talker by the microphone; transmitting an audio signal obtained by processing the first audio signal by an audio communication application installed to be executable by the computer to the one or more other terminals via the network; acquiring a second audio signal from the one or more other terminals processed by the audio communication application installed to be executable by the computer; and detecting whether an audio feedback is present based on the first audio signal before being processed by the audio communication application.

Further, the present disclosure provides an audio feedback detection method including: acquiring a first audio signal collected by a microphone; acquiring a second audio signal from an audio communication application to be output to a speaker; and determining whether audio feedback is present based on the first audio signal which has not been processed by the audio communication application.

According to the present disclosure, occurrence of an audio feedback that may occur with another audio input and output apparatus including a microphone and a speaker can be suppressed.

### BRIEF DESCRIPTION OF DRAWINGS

FIG. 1 is a diagram showing a system configuration example of a web conference system according to a first embodiment.

FIG. 2 is a block diagram showing a hardware configuration example of a PC according to the first embodiment.

FIG. 3 is a diagram showing an operation outline example of the PC according to the first embodiment.

FIG. 4 is a block diagram showing a first configuration example of an audio signal processing unit.

FIG. 5 is a diagram showing an example of frequency characteristics of a microphone signal and a speaker signal.

FIG. 6 is a block diagram showing a second configuration example of the audio signal processing unit.

FIG. 7 is a block diagram showing a third configuration example of the audio signal processing unit.

FIG. 8 is a block diagram showing a fourth configuration example of the audio signal processing unit.

FIG. 9 is a flowchart of an overall operation procedure example of the PC according to the first embodiment.

FIG. 10 is a flowchart of an operation procedure example of peak determination processing as a subroutine.

FIG. 11 is a flowchart of a first example of an operation procedure of gain adjustment processing as a subroutine.

FIG. 12 is a flowchart of a second example of the operation procedure of the gain adjustment processing as a subroutine.

### DETAILED DESCRIPTION

Hereinafter, an embodiment specifically disclosing an audio feedback detection apparatus and an audio feedback detection method according to the present disclosure will be described in detail with reference to the drawings as appropriate. However, an unnecessary detailed description may be omitted. For example, a detailed description of a well-known matter or a repeated description of substantially the same configuration may be omitted. This is to avoid unnecessary redundancy in the following description and to facilitate understanding for those skilled in the art. It should be noted that the accompanying drawings and the following description are provided for a thorough understanding of the present disclosure by those skilled in the art, and are not intended to limit the subject matter recited in the claims.

First, before describing a configuration of a web conference system 100 according to a first embodiment, problems to be solved by the web conference system 100 will be briefly described. It is assumed that a plurality of PCs (personal computers) are connected to the same network at an own place (for example, the same space such as the same conference room), and a web conference is performed between the plurality of PCs and a PC at a partner's place connected to the network.

In this case, for example, when both a microphone and a speaker included in each of the plurality of PCs at the own place are turned on, an audio feedback occurs. There is a problem in that, for example, an audio signal output from a speaker of a first PC at the own place is collected by a microphone of a second PC at the same own place, and an echo of the audio signals continues in a loop shape, thereby causing the unpleasant audio feedback. When the audio feedback occurs, a progress of the web conference does not proceed as expected, and a work efficiency may deteriorate. Therefore, it is necessary to detect the occurrence of the audio feedback in real time and interrupt a loop by blocking the audio signal (hereinafter, may be referred to as a “speaker signal”) input to the speaker and output from the speaker or the audio signal (hereinafter, may be referred to as a “microphone signal”) collected by the microphone.

Therefore, the following first embodiment describes an example of a computer (PC) including a microphone and a speaker as an example of an audio feedback detection apparatus that suppresses occurrence of an audio feedback that may occur between the computer (PC) and another PC including a microphone and a speaker provided at the same place in a configuration of one computer (PC) in the above-described web conference system.

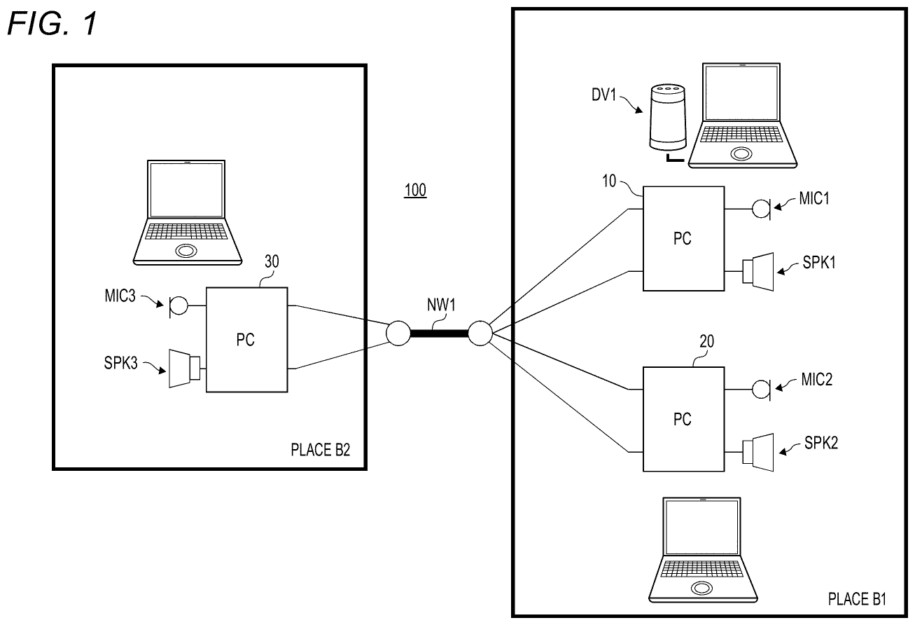

FIG. 1 is a diagram showing a system configuration example of the web conference system 100 according to the first embodiment. The web conference system 100 includes a plurality of PCs 10, 20, and 30 connected to each other via a network NW1. The PC 10 is disposed on a place B1 side where the web conference system 100 is used, and includes a microphone MIC1 and a speaker SPK1. Similarly to the PC 10, the PC 20 is disposed on the place B1 side where the web conference system 100 is used, and includes a microphone MIC2 and a speaker SPK2. The PC 30 is disposed on a place B2 side where the web conference system 100 is used, and includes a microphone MIC3 and a speaker SPK3. That is, the PCs 10 and 20 are disposed at the same place B1 (own place), and the PC 30 is disposed at another place B2 (partner's place). Each of the places B1 and B2 may be, for example, a space such as a conference room or a meeting corner in a company, and it does not matter in what kind of space the place is specifically configured. The network NW1 may be a wired network, a wireless network, or a combination thereof. The wired network may be, for example, a wired local area network (LAN) represented by Ethernet (registered trademark), and a type thereof is not particularly limited. The wireless network may be a wireless LAN represented by, for example, Wi-Fi (registered trademark), and a type thereof is not particularly limited.

Instead of the microphone MIC1 and the speaker SPK1 incorporated in the PC 10, an external speaker microphone DV1 integrally provided with configurations and functions of the microphone and the speaker may be connected to the PC 10 for use. That is, the speaker microphone DV1 has both a function of the microphone MIC1 that collects a voice based on an utterance of an operator (talker) of the PC 10 and a function of the speaker SPK1 that outputs a voice from the PCs 20 and 30 other than the PC 10. FIG. 1 shows an example in which the external speaker microphone DV1 is connected to the PC 10, whereas the external speaker microphone DV1 may be connected to the PC 30 other than the PC 10.

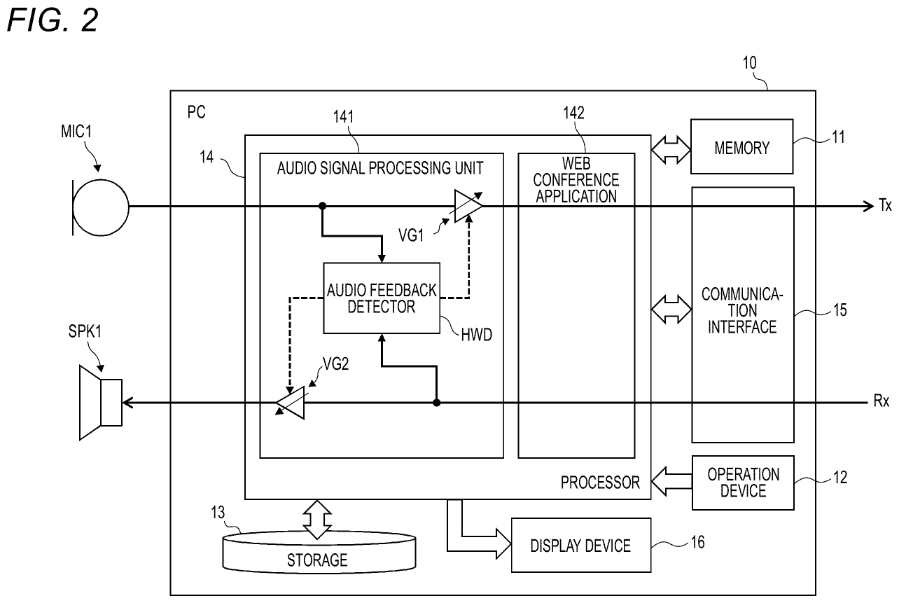

FIG. 2 is a block diagram showing a hardware configuration example of the PC 10 according to the first embodiment. FIG. 2 shows the PC 10 among the PCs 10, 20, and 30 shown in FIG. 1 as an example, and the PCs 20 and 30 also have the same configuration (see FIG. 2). Therefore, in the description of FIG. 2, the “PC 10” may be read as the “PC 20” or the “PC 30”, and when this reading is performed, the “PC 20” is read as the “PC 30” or the “PC 10”, and the “PC 30” is read as the “PC 10” or the “PC 20”.

The PC 10 includes a memory 11, an operation device 12, a storage 13, a processor 14, a communication interface 15, the microphone MIC1, and the speaker SPK1. These units are connected to each other via an internal bus (not shown) or the like such that data or signals can be transmitted and received.

The memory 11 includes at least a random access memory (RAM) as a work memory used when, for example, the processor 14 performs various kinds of processing, and a read only memory (ROM) that stores a program (including a program of a web conference application 142) for defining the various kinds of processing performed by the processor 14 and data used during the execution of the program. The data or information generated or acquired by the processor 14 is temporarily stored in the RAM. In the ROM, the program for defining the various kinds of processing performed by the processor 14 and the data used during the execution of the program are written.

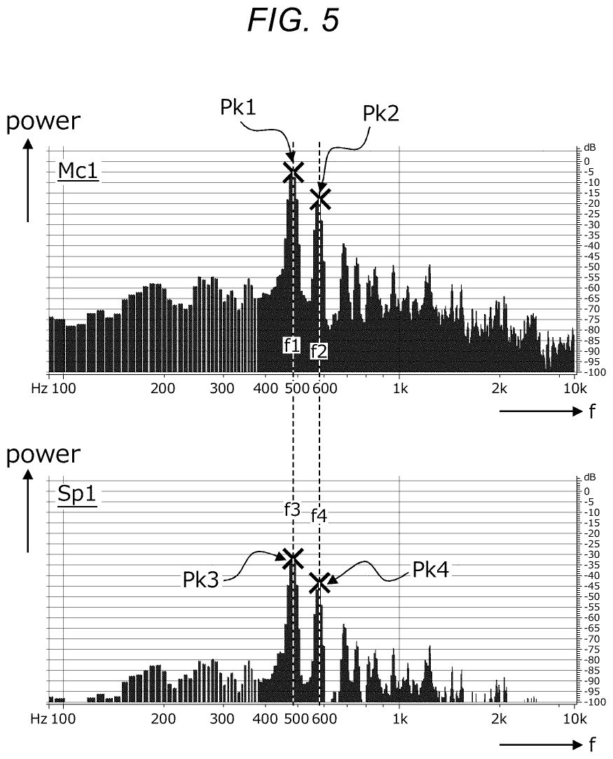

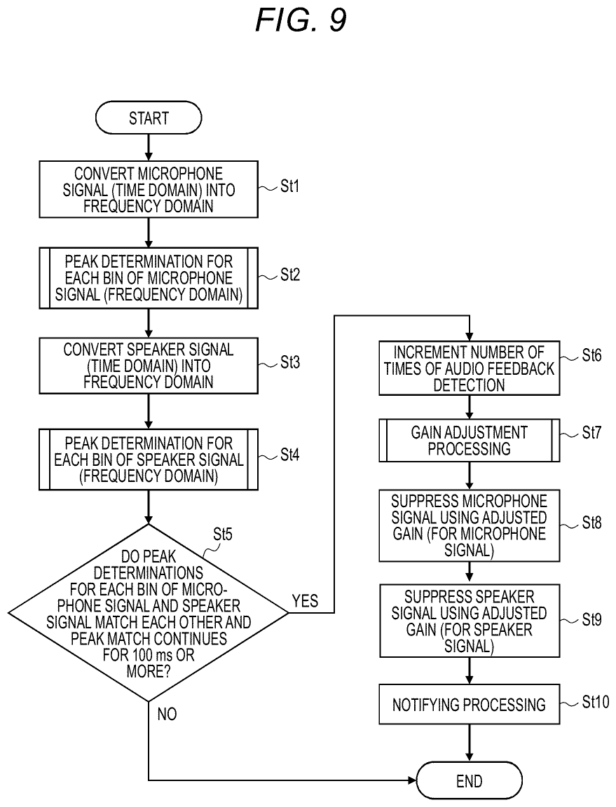

For example, the memory 11 stores a threshold A and a threshold B. The threshold A is a value used by the processor 14 to determine a protrusion degree with respect to a surrounding bin (see FIG. 9) in a frequency domain (to be described later) of the microphone signal or the speaker signal, and is a fixed value. The threshold B is a value used to prevent an audio feedback from being erroneously determined when power of the microphone signal or the speaker signal in the frequency domain (to be described later) is small, and is a fixed value different from the threshold A. For example, a microphone signal Mc1 in the frequency domain of FIG. 5 has a plurality of peaks per 1000 Hz (1 kHz), since the plurality of peaks are not peaks based on the audio feedback, the threshold B is provided so as to prevent the plurality of peaks from being erroneously detected as the peaks based on the audio feedback.

For example, the memory 11 stores current values (for example, initial values) of a first gain and a second gain set in variable amplifiers VG1 and VG2. However, when the occurrence of an audio feedback is detected by an audio feedback detector HWD as described later, at least one of the first gain and the second gain is adjusted to be lowered, and thus the memory 11 may store at least one of the first gain and the second gain. The first gain and the second gain before the adjustment may be discarded from the memory 11, or may be continuously stored.

In addition, for example, the memory 11 temporarily stores the number of times of audio feedback detection detected by the audio feedback detector HWD of an audio signal processing unit 141 of the processor 14 during the web conference using the web conference system 100. Since the number of times of detection indicates the number of times the audio feedback is counted by the audio feedback detector HWD during the web conference using the web conference system 100, and for example, when the web conference is ended, the number of times of detection is reset to zero.

The operation device 12 is configured using, for example, at least one of devices such as a mouse, a keyboard, a touch pad, and a touch panel. The operation device 12 receives an input operation performed by the operator (that is, a user of the web conference system 100) who uses the PC 10, and inputs a signal corresponding to the input operation to the processor 14. In the following description, the operator who uses the PC 10 may be referred to as a “PC 10 user”, an operator who uses the PC 20 may be referred to as a “PC 20 user”, and an operator who uses the PC 30 may be referred to as a “PC 30 user” for convenience.

The storage 13 is configured using a storage medium such as a flash memory, a hard disk drive (HDD), or a solid state drive (SSD). The storage 13 stores the data or the information generated or acquired by the processor 14 regardless of whether the PC 10 is powered on.

The processor 14 is configured using a semiconductor chip on which at least one of electronic devices such as a central processing unit (CPU), a digital signal processor (DSP), a graphical processing unit (GPU), and a field programmable gate array (FPGA) is mounted. The processor 14 functions as a controller that controls an overall operation of the PC 10, and performs control processing for controlling operations of each of the units of the PC 10, data input and output processing with each of the units of the PC 10, data calculation processing, and data storage processing. The processor 14 can functionally execute the audio signal processing unit 141 and the web conference application 142 by using the program and the data stored in the ROM of the memory 11. The processor 14 uses the RAM of the memory 11 during the operation, and temporarily stores the data or the information generated or acquired by the processor 14 in the RAM of the memory 11.

The audio signal processing unit 141 includes at least the audio feedback detector HWD and the variable amplifiers VG1 and VG2. The audio signal processing unit 141 inputs an audio signal (that is, a microphone signal in a time domain as an example of a first audio signal) of the PC 10 user after being collected by the microphone MIC1 and before being input to the web conference application 142 and an audio signal (that is, a speaker signal in a time domain as an example of a second audio signal) after being processed by the web conference application 142 and before being input to the speaker SPK1 to the audio feedback detector HWD. Although not shown, the audio signal processing unit 141 includes a first audio input unit that acquires the audio signal (that is, the audio signal to be input to the audio feedback detector HWD) collected by the microphone MIC1, a first audio output unit that outputs the audio signal (that is, an audio signal amplified or suppressed by the variable amplifier VG1) to be output to the web conference application 142, a second audio input unit that acquires the audio signal (that is, an audio signal to be input to the audio feedback detector HWD) received via the web conference application 142, and a second audio output unit that outputs the audio signal (that is, an audio signal amplified or suppressed by the variable amplifier VG2) to be output to the speaker SPK1.

The audio signal processing unit 141 detects whether the audio feedback occurs in the web conference system 100 using the audio feedback detector HWD based on a correlation between frequency characteristics of the input microphone signal and the input speaker signal. In response to the detection of the audio feedback, the audio signal processing unit 141 adjusts at least one of the first gain for suppressing the microphone signal in the time domain described above and the second gain for suppressing the speaker signal in the time domain described above in the variable amplifiers VG1 and VG2. For example, the audio signal processing unit 141 adjusts the second gain to be larger than the first gain. Accordingly, since the speaker signal output from the PC 10 is more suppressed than the microphone signal to be transmitted to the other PCs 20 and 30, the audio feedback in the web conference system 100 can be effectively suppressed. A configuration example of the audio feedback detector HWD will be described later with reference to FIGS. 5 to 8.

The web conference application 142 is an application executed by the processor 14 during the web conference using the web conference system 100, and is installed in each of the PCs 10, 20, and 30 constituting the web conference system 100 in an executable manner. The web conference application 142 is, for example, an application called Microsoft Teams (registered trademark) provided by Microsoft Corporation or an application called Zoom (registered trademark) provided by Zoom Video Communications, and is not limited to thereto. The web conference application 142 performs various types of signal processing, such as amplification and filtering, on the microphone signal based on sound collected by the microphone MIC1, and outputs the microphone signal to the communication interface 15. The web conference application 142 performs various types of signal processing such as amplification and filtering on the audio signal (speaker signal) received by the communication interface 15, and outputs the audio signal to the audio signal processing unit 141.

The communication interface 15 is configured using, for example, a communication device capable of transmitting and receiving the data or the information to and from the network NW1. The communication interface 15 transmits, for example, the data or the information (for example, an audio signal Tx of the PC 10 user processed by the web conference application 142) generated or acquired by the processor 14 to the other PCs 20 and 30 via the network NW1. The communication interface 15 receives data or information (for example, an audio signal Rx processed by a web conference application installed in the PC 20 or the PC 30 based on an utterance of the PC 20 user or the PC 30 user) transmitted from the other PCs 20 and 30, and inputs the data or the information to the processor 14.

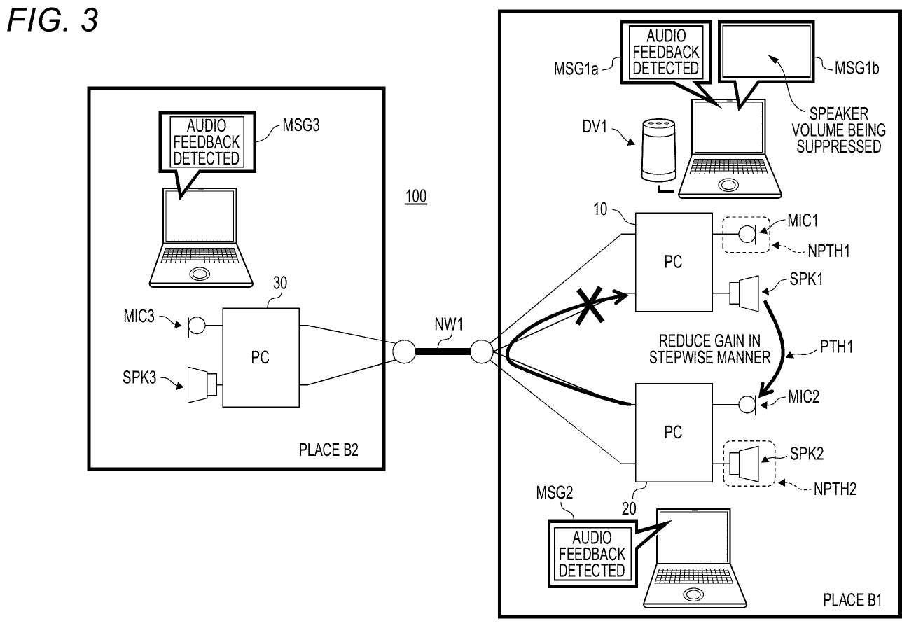

A display device 16 is configured using, for example, a liquid crystal display (LCD) or an organic electroluminescence (EL) display, and displays the data or the information (for example, display screens MSG1a and MSG1b shown in FIG. 3) generated or acquired by the processor 14.

The microphone MIC1 collects the sound based on the utterance (for example, an utterance during the web conference using the web conference system 100) of the PC 10 user, and inputs the audio signal obtained by the sound collection to the processor 14. Specifically, the audio signal from the microphone MIC1 is input to the audio signal processing unit 141 of the processor 14.

The speaker SPK1 acoustically outputs the audio signal (for example, an audio signal based on the collection of the sound made by the PC 20 user or the PC 30 user during the web conference using the web conference system 100) processed by the processor 14. A part of the audio signal output from the speaker SPK1 goes around (that is, is diffracted) and is collected by the microphone MIC2 included in another PC 20 (see FIG. 3).

Next, an operation outline example of the PC 10 according to the first embodiment will be described with reference to FIG. 3. FIG. 3 is a diagram showing the operation outline example of the PC according to the first embodiment. FIG. 3 shows a use case in which the PC 10 detects the audio feedback among the PCs 10, 20, and 30 constituting the web conference system 100, and the PC 20 may detect the audio feedback instead of the PC 10. Among the elements shown in FIG. 3, those having the same configuration as the corresponding elements shown in FIG. 1 are denoted by the same reference numerals, the description thereof will be simplified or omitted, and different contents will be described.

In FIG. 3, when each of the PCs 10, 20, and 30 is connected to the network NW1 and the web conference using the web conference system 100 is started, the unpleasant audio feedback occurs when the microphones MIC1 and MIC2 and the speakers SPK1 and SPK2 of the PCs 10 and 20 disposed at the same place B1 are turned on. The audio feedback occurs in, for example, an audio feedback occurrence path PTH1.

That is, as shown in FIG. 3, a part of the audio signal output from the speaker SPK1 of the PC 10 goes around to the microphone MIC2 of the PC 20 existing in the vicinity of the PC 10 and is collected by the microphone MIC2, so that an echo of the audio signal continues in a loop shape (for example, the audio feedback occurrence path PTH1 is formed), whereby the audio feedback occurs. Therefore, for example, when the audio feedback occurs due to the formation of the audio feedback occurrence path PTH1, the speaker SPK1 of the PC 10 and the microphone MIC2 of the PC 20 are located on the audio feedback occurrence path PTH1, while the microphone MIC1 of the PC 10 and the speaker SPK2 of the PC 20 are located on audio feedback non-occurrence paths NPTH1 and NPTH2, respectively.

The processor 14 of the PC 10 according to the first embodiment can detect whether the audio feedback is present based on the correlation between the frequency characteristics of the microphone signal obtained by the sound collection by the microphone MIC1 and the speaker signal output from the speaker SPK1 (details will be described later). In response to the detection of the occurrence of the audio feedback, the processor 14 of the PC 10 performs processing (gain adjustment processing to be described later) of decreasing a gain to be multiplied by at least one of the microphone signal and the speaker signal in a stepwise manner in order to suppress at least one of the microphone signal in the time domain based on the sound collection by the microphone MIC1 and the speaker signal in the time domain before being input to the speaker SPK1. Accordingly, the occurrence of the audio feedback is gradually suppressed.

In response to the detection of the occurrence of an audio feedback, the processor 14 of the PC 10 displays, on the display device 16, a display screen MSG1a for notifying the occurrence of an audio feedback or a display screen MSG1b for notifying that a volume of the audio signal output from the speaker SPK1 is being suppressed. The PC 10 may display both the display screens MSG1a and MSG1b on the display device 16. Thus, the PC 10 user can visually recognize via the display device 16 that the audio feedback occurs during the web conference using the web conference system 100.

When the PC 10 detects the audio feedback, the processor 14 of the PC 10 may transmit display instructions of display screens MSG2 and MSG3 for notifying the occurrence of an audio feedback to the PCs 20 and 30 via the network NW1. The PCs 20 and 30 generate the display screens MSG2 and MSG3 based on the display instructions from the PC 10 and display the display screens MSG2 and MSG3 on the display device, respectively. Each of the display screens MSG2 and MSG3 may be received by each of the PCs 20 and 30 from the PC 10 together with the above-described display instructions generated by the PC 10. Accordingly, each of the PC 20 user and the PC 30 user can visually recognize that the audio feedback occurs during the web conference using the web conference system 100 via the corresponding display devices 16 of the PCs 20 and 30.

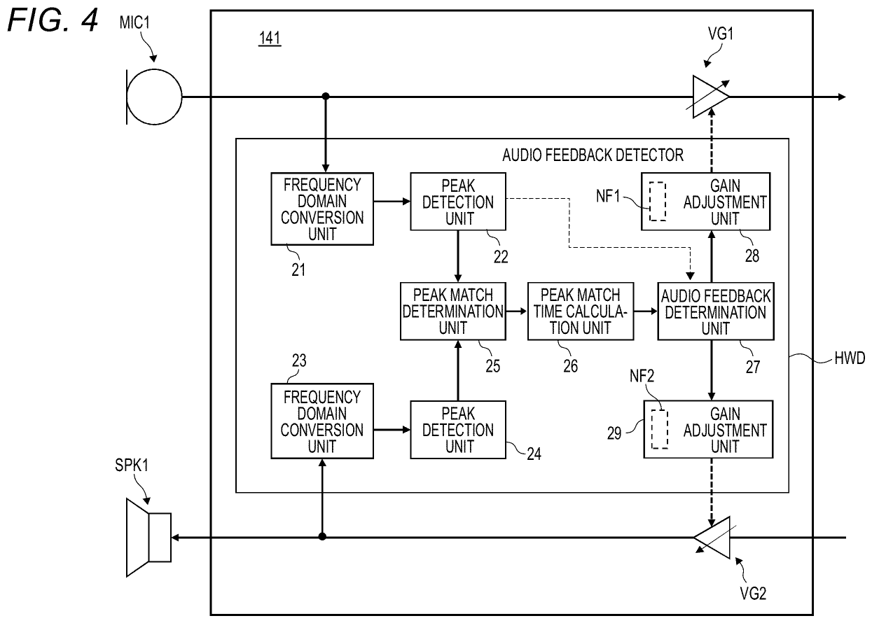

Next, a configuration example of the audio feedback detector HWD included in the PC 10 according to first embodiment will be described with reference to FIGS. 4 and 5. FIG. 4 is a block diagram showing a first configuration example of the audio signal processing unit. FIG. 5 is a diagram showing an example of frequency characteristics of the microphone signal and the speaker signal. A horizontal axis of FIG. 5 represents a frequency, and a vertical axis of FIG. 5 represents the power (for example, spectrum) of each signal. Among the elements shown in FIG. 4, those having the same configuration as the corresponding elements shown in FIG. 2 are denoted by the same reference numerals, the description thereof will be simplified or omitted, and different contents will be described.

The audio signal processing unit 141 includes at least the audio feedback detector HWD and the variable amplifiers VG1 and VG2. The audio feedback detector HWD includes a frequency domain conversion unit 21, a peak detection unit 22, a frequency domain conversion unit 23, a peak detection unit 24, a peak match determination unit 25, a peak match time calculation unit 26, an audio feedback determination unit 27, and gain adjustment units 28 and 29. The audio feedback detector HWD temporarily stores the input microphone signal and the input speaker signal in the memory 11, and cooperates with the memory 11 to perform corresponding processing in each of the units constituting the audio feedback detector HWD.

The frequency domain conversion unit 21 converts, for example, the microphone signal in the time domain into the microphone signal Mc1 in the frequency domain by performing Fourier transform on the microphone signal from the microphone MIC1, and outputs the microphone signal Mc1 in the frequency domain to the peak detection unit 22. In the configuration example of the audio signal processing unit 141 shown in FIG. 4, the microphone signal from the microphone MIC1 before being amplified or suppressed by the variable amplifier VG1 is input to the frequency domain conversion unit 21.

Based on a frequency characteristic of the microphone signal Mc1 in the frequency domain from the frequency domain conversion unit 21, the peak detection unit 22 detects first peak frequencies f1 and f2 (see FIG. 5) at which the power of the microphone signal Mc1 obtained for each bin (see FIG. 9) of the microphone signal Mc1 is a maximum value (that is, peaks Pk1 and Pk2), and outputs a detection result to the peak match determination unit 25. For example, FIG. 5 shows that the first peak frequency f1 is about 500 Hz and the first peak frequency f2 is about 600 Hz.

The frequency domain conversion unit 23 converts, for example, the speaker signal in the time domain into a speaker signal Sp1 in the frequency domain by performing Fourier transform on the speaker signal before being input to the speaker SPK1, and outputs the speaker signal Sp1 in the frequency domain to the peak detection unit 24. In the configuration example of the audio signal processing unit 141 shown in FIG. 4, the speaker signal amplified or suppressed by the variable amplifier VG2 is input to the frequency domain conversion unit 23.

Based on a frequency characteristic of the speaker signal Sp1 in the frequency domain from the frequency domain conversion unit 23, the peak detection unit 24 detects second peak frequencies f3 and f4 (see FIG. 5) at which power of the speaker signal Sp1 is a maximum value (that is, peaks Pk3 and Pk4), and outputs a detection result to the peak match determination unit 25. For example, FIG. 5 shows that the second peak frequency f3 is about 500 Hz and the second peak frequency f4 is about 600 Hz.

The peak match determination unit 25 determines whether the first peak frequencies (for example, f1 and f2 shown in FIG. 5) detected by the peak detection unit 22 match the second peak frequencies (for example, f3 and f4 shown in FIG. 5) detected by the peak detection unit 24 based on the detection results from the peak detection units 22 and 24. The peak match determination unit 25 outputs a determination result to the peak match time calculation unit 26. In FIG. 5, the first peak frequency f1 is equal to the second peak frequency and the first peak frequency f2 is equal to the second peak frequency f4.

When the determination result from the peak match determination unit 25 indicates that the first peak frequency matches the second peak frequency, the peak match time calculation unit 26 determines whether a time for which the peaks match each other is continuous for a predetermined time (for example, 100 milliseconds) or more. The predetermined time is not limited to 100 milliseconds. The peak match time calculation unit 26 outputs a determination result to the audio feedback determination unit 27.

The audio feedback determination unit 27 determines whether the audio feedback occurs based on the determination result from the peak match time calculation unit 26. Specifically, the audio feedback determination unit 27 determines that the audio feedback occurs when it is determined that the first peak frequency detected by the peak detection unit 22 and the second peak frequency detected by the peak detection unit 24 match each other and the match time is continuous for the predetermined time or more. The audio feedback determination unit 27 outputs the determination result to each of the gain adjustment units 28 and 29.

When the determination result indicates that the occurrence of an audio feedback is detected, the audio feedback determination unit 27 outputs an instruction to adjust the first gain and the second gain to the gain adjustment units 28 and 29.

When the determination result from the audio feedback determination unit 27 indicates that the occurrence of an audio feedback is detected, the gain adjustment unit 28 adjusts the first gain by which the microphone signal is multiplied to suppress the power (level) of the microphone signal to be lower than the current value (for example, the initial value) stored in the memory 11 based on the instruction from the audio feedback determination unit 27 and the number of times of audio feedback detection stored in the memory 11. The gain adjustment unit 28 outputs the adjusted first gain to the variable amplifier VG1. An amount of reduction of the first gain from the current value is set in advance (for example, is stored in the memory 11). The gain adjustment unit 28 may include an adaptive notch filter NF1. The adaptive notch filter NF1 adjusts and sets a notch suppression gain (that is, a gain for suppressing the microphone signal) based on the determination result of the audio feedback determination unit 27, and outputs the set notch suppression gain (an example of the first gain described above) to the variable amplifier VG1. When the gain adjustment unit 28 receives a determination result indicating that the audio feedback is not detected from the audio feedback determination unit 27 after adjusting the first gain, the gain adjustment unit 28 may gradually or at once return the adjusted first gain to an original value.

When the determination result from the audio feedback determination unit 27 indicates that the occurrence of an audio feedback is detected, the gain adjustment unit 29 adjusts the second gain by which the speaker signal is multiplied to suppress the power (level) of the speaker signal to be lower than the current value (for example, the initial value) stored in the memory 11 based on the instruction from the audio feedback determination unit 27 and the number of times of audio feedback detection stored in the memory 11. The gain adjustment unit 29 outputs the adjusted second gain to the variable amplifier VG2. An amount of reduction of the second gain from the current value is set in advance (for example, is stored in the memory 11), and may be larger, smaller, or the same as the amount of reduction of the first gain from the current value described above. The gain adjustment unit 29 may include an adaptive notch filter NF2. The adaptive notch filter NF2 adjusts and sets a notch suppression gain (that is, a gain for suppressing the speaker signal) based on the determination result of the audio feedback determination unit 27, and outputs the set notch suppression gain (an example of the second gain described above) to the variable amplifier VG2. When the gain adjustment unit 29 receives a determination result indicating that the audio feedback is not detected from the audio feedback determination unit 27 after adjusting the second gain, the gain adjustment unit 29 may gradually or at once return the adjusted second gain to an original value.

The variable amplifier VG1 is disposed such that the microphone signal from the microphone MIC1 is input to the variable amplifier VG1 before being input to the web conference application 142, and amplifies or suppresses the microphone signal using the first gain instructed by the audio feedback detector HWD. For example, the variable amplifier VG1 amplifies or suppresses the microphone signal based on the adjusted first gain from the gain adjustment unit 28. Therefore, when the first gain is reduced due to the adjustment performed by the gain adjustment unit 28, the microphone signal is suppressed by the variable amplifier VG1.

The variable amplifier VG2 is disposed such that the speaker signal processed by the web conference application 142 is input to the variable amplifier VG2 before being input to the speaker SPK1, and amplifies or suppresses the speaker signal using the second gain instructed by the audio feedback detector HWD. For example, the variable amplifier VG2 amplifies or suppresses the speaker signal based on the adjusted second gain from the gain adjustment unit 29. Therefore, when the second gain is reduced due to the adjustment performed by the gain adjustment unit 29, the speaker signal is suppressed by the variable amplifier VG2.

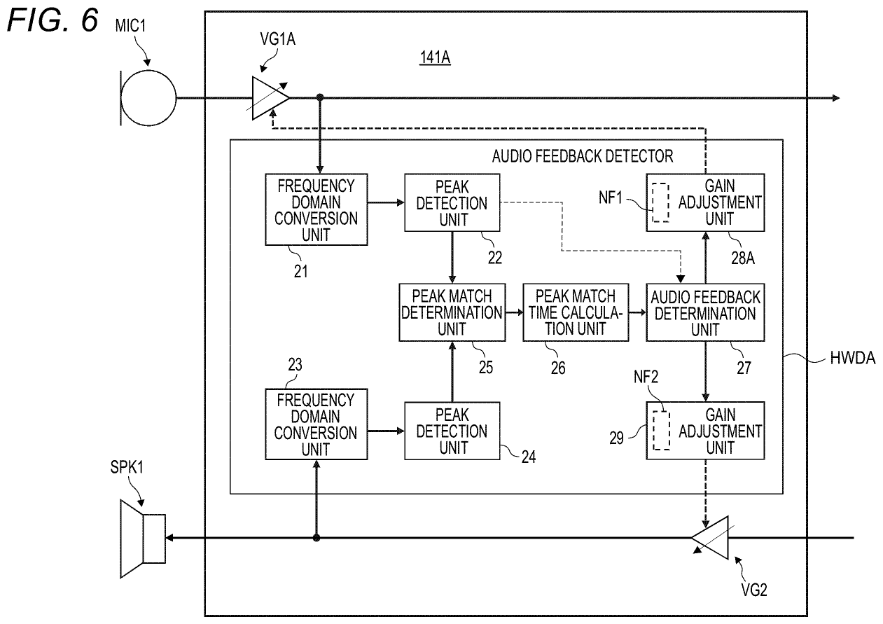

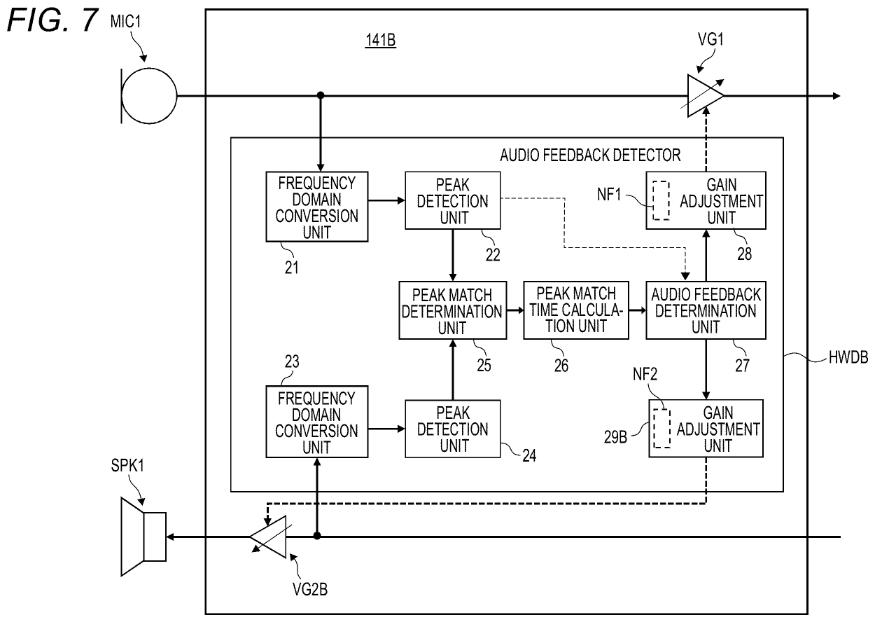

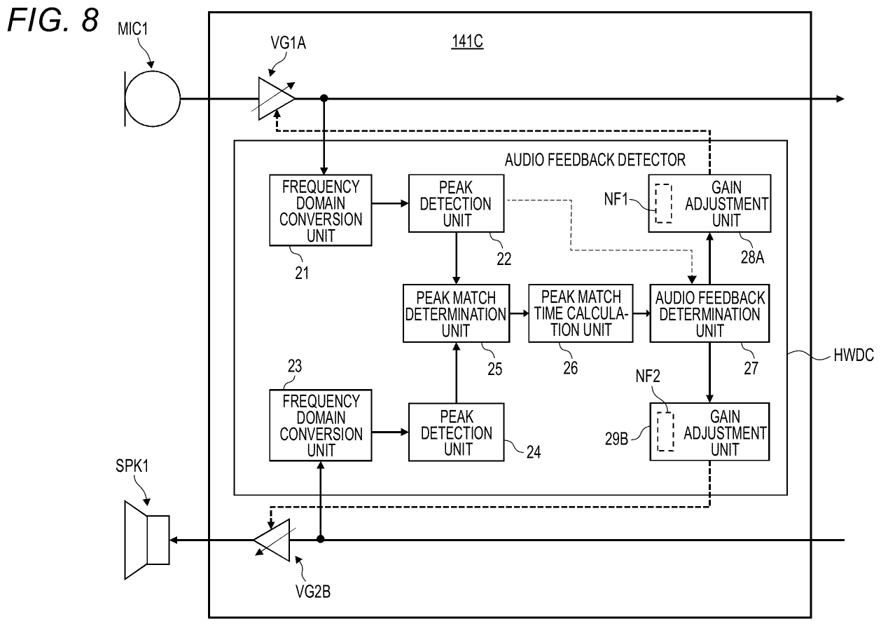

The configuration of the audio signal processing unit of the processor 14 is not limited to the configuration of the audio signal processing unit 141 shown in FIG. 5, and may be audio signal processing units 141A, 141B, and 141C shown in FIGS. 6 to 8, respectively. FIG. 6 is a block diagram showing a second configuration example of the audio signal processing unit. FIG. 7 is a block diagram showing a third configuration example of the audio signal processing unit. FIG. 8 is a block diagram showing a fourth configuration example of the audio signal processing unit. In descriptions of FIGS. 6 to 8, the same elements as those of the audio signal processing unit 141 shown in FIG. 4 are denoted by the same reference numerals, the description thereof will be simplified or omitted, and different contents will be described.

Similarly to the audio signal processing unit 141 shown in FIG. 4, the audio signal processing unit 141A shown in FIG. 6 includes at least an audio feedback detector HWDA and variable amplifiers VG1A and VG2. The audio feedback detector HWDA includes the frequency domain conversion unit 21, the peak detection unit 22, the frequency domain conversion unit 23, the peak detection unit 24, the peak match determination unit 25, the peak match time calculation unit 26, the audio feedback determination unit 27, and gain adjustment units 28A and 29.

In the configuration example of the audio signal processing unit 141A shown in FIG. 6, the microphone signal from the microphone MIC1 after being amplified or suppressed by the variable amplifier VG1A is input to the frequency domain conversion unit 21.

When the determination result from the audio feedback determination unit 27 indicates that the occurrence of an audio feedback is detected, the gain adjustment unit 28A adjusts the first gain by which the microphone signal is multiplied to suppress the power (level) of the microphone signal to be lower than the current value (for example, the initial value) stored in the memory 11 based on the instruction from the audio feedback determination unit 27 and the number of times of audio feedback detection stored in the memory 11. The gain adjustment unit 28A outputs the adjusted first gain to the variable amplifier VG1A. The gain adjustment unit 28A may include the adaptive notch filter NF1. The adaptive notch filter NF1 adjusts and sets the notch suppression gain (that is, the gain for suppressing the microphone signal) based on the determination result of the audio feedback determination unit 27, and outputs the set notch suppression gain (the example of the first gain described above) to the variable amplifier VG1A.

The variable amplifier VG1A is disposed such that the microphone signal from the microphone MIC1 is input to the variable amplifier VG1A before being input to each of the frequency domain conversion unit 21 and the web conference application 142. The variable amplifier VG1A amplifies or suppresses the microphone signal using the first gain indicated by the audio feedback detector HWDA. For example, the variable amplifier VG1A amplifies or suppresses the microphone signal based on the adjusted first gain from the gain adjustment unit 28A. Therefore, when the first gain is reduced due to the adjustment performed by the gain adjustment unit 28A, the microphone signal is suppressed by the variable amplifier VG1A and is input to the web conference application 142.

Similarly to the audio signal processing unit 141 shown in FIG. 4, the audio signal processing unit 141A shown in FIG. 7 includes at least an audio feedback detector HWDB and variable amplifiers VG1 and VG2B. The audio feedback detector HWDB includes the frequency domain conversion unit 21, the peak detection unit 22, the frequency domain conversion unit 23, the peak detection unit 24, the peak match determination unit 25, the peak match time calculation unit 26, the audio feedback determination unit 27, and gain adjustment units 28 and 29B.

In the configuration example of the audio signal processing unit 141A shown in FIG. 7, the speaker signal before being amplified or suppressed by the variable amplifier VG2B is input to the frequency domain conversion unit 23.

When the determination result from the audio feedback determination unit 27 indicates that the occurrence of an audio feedback is detected, the gain adjustment unit 29B adjusts the second gain by which the speaker signal is multiplied to suppress the power (level) of the speaker signal to be lower than the current value (for example, the initial value) stored in the memory 11 based on the instruction from the audio feedback determination unit 27 and the number of times of audio feedback detection stored in the memory 11. The gain adjustment unit 29B outputs the adjusted second gain to the variable amplifier VG2B. The gain adjustment unit 29B may include the adaptive notch filter NF2. The adaptive notch filter NF2 adjusts and sets the notch suppression gain (that is, the gain for suppressing the speaker signal) based on the determination result of the audio feedback determination unit 27, and outputs the set notch suppression gain (an example of the second gain described above) to the variable amplifier VG2B.

The variable amplifier VG2B is disposed at a stage preceding the speaker SPK1 such that the speaker signal is input to the variable amplifier VG2B after being input to the frequency domain conversion unit 23. The variable amplifier VG2B amplifies or suppresses the speaker signal using the second gain instructed from the audio feedback detector HWDB. For example, the variable amplifier VG2B amplifies or suppresses the speaker signal based on the adjusted second gain from the gain adjustment unit 29B. Therefore, when the second gain is reduced due to the adjustment performed by the gain adjustment unit 29B, the speaker signal is suppressed by the variable amplifier VG2B and input to the speaker SPK1.

Similarly to the audio signal processing unit 141 shown in FIG. 4, the audio signal processing unit 141C shown in FIG. 8 includes at least an audio feedback detector HWDB and the variable amplifiers VG1A and VG2B. The audio feedback detector HWDB includes the frequency domain conversion unit 21, the peak detection unit 22, the frequency domain conversion unit 23, the peak detection unit 24, the peak match determination unit 25, the peak match time calculation unit 26, the audio feedback determination unit 27, and gain adjustment units 28A and 29B.

In the configuration example of the audio signal processing unit 141C shown in FIG. 8, the microphone signal from the microphone MIC1 after being amplified or suppressed by the variable amplifier VG1A is input to the frequency domain conversion unit 21, and the speaker signal before being amplified or suppressed by the variable amplifier VG2B is input to the frequency domain converting unit 23.

When the determination result from the audio feedback determination unit 27 indicates that the occurrence of an audio feedback is detected, the gain adjustment unit 28A adjusts the first gain by which the microphone signal is multiplied to suppress the power (level) of the microphone signal to be lower than the current value (for example, the initial value) stored in the memory 11 based on the instruction from the audio feedback determination unit 27 and the number of times of audio feedback detection stored in the memory 11. The gain adjustment unit 28A outputs the adjusted first gain to the variable amplifier VG1A. The gain adjustment unit 28A may include the adaptive notch filter NF1. The adaptive notch filter NF1 adjusts and sets the notch suppression gain (that is, the gain for suppressing the microphone signal) based on the determination result of the audio feedback determination unit 27, and outputs the set notch suppression gain (the example of the first gain described above) to the variable amplifier VG1A.

The variable amplifier VG1A is disposed such that the microphone signal from the microphone MIC1 is input to the variable amplifier VG1A before being input to each of the frequency domain conversion unit 21 and the web conference application 142. The variable amplifier VG1A amplifies or suppresses the microphone signal using the first gain indicated by the audio feedback detector HWDA. For example, the variable amplifier VG1A amplifies or suppresses the microphone signal based on the adjusted first gain from the gain adjustment unit 28A. Therefore, when the first gain is reduced due to the adjustment performed by the gain adjustment unit 28A, the microphone signal is suppressed by the variable amplifier VG1A and is input to the web conference application 142.

When the determination result from the audio feedback determination unit 27 indicates that the occurrence of an audio feedback is detected, the gain adjustment unit 29B adjusts the second gain by which the speaker signal is multiplied to suppress the power (level) of the speaker signal to be lower than the current value (for example, the initial value) stored in the memory 11 based on the instruction from the audio feedback determination unit 27 and the number of times of audio feedback detection stored in the memory 11. The gain adjustment unit 29B outputs the adjusted second gain to the variable amplifier VG2B. The gain adjustment unit 29B may include the adaptive notch filter NF2. The adaptive notch filter NF2 adjusts and sets the notch suppression gain (that is, the gain for suppressing the speaker signal) based on the determination result of the audio feedback determination unit 27, and outputs the set notch suppression gain (an example of the second gain described above) to the variable amplifier VG2B.

The variable amplifier VG2B is disposed at a stage preceding the speaker SPK1 such that the speaker signal is input to the variable amplifier VG2B after being input to the frequency domain conversion unit 23. The variable amplifier VG2B amplifies or suppresses the speaker signal using the second gain instructed from the audio feedback detector HWDB. For example, the variable amplifier VG2B amplifies or suppresses the speaker signal based on the adjusted second gain from the gain adjustment unit 29B. Therefore, when the second gain is reduced due to the adjustment performed by the gain adjustment unit 29B, the speaker signal is suppressed by the variable amplifier VG2B and input to the speaker SPK1.

Next, an overall operation procedure of the PC 10 according to the first embodiment will be described with reference to FIG. 9. FIG. 9 is a flowchart of an example of the overall operation procedure of the PC 10 according to the first embodiment. Each of processing shown in FIG. 9 is mainly executed by the processor 14 of the PC 10.

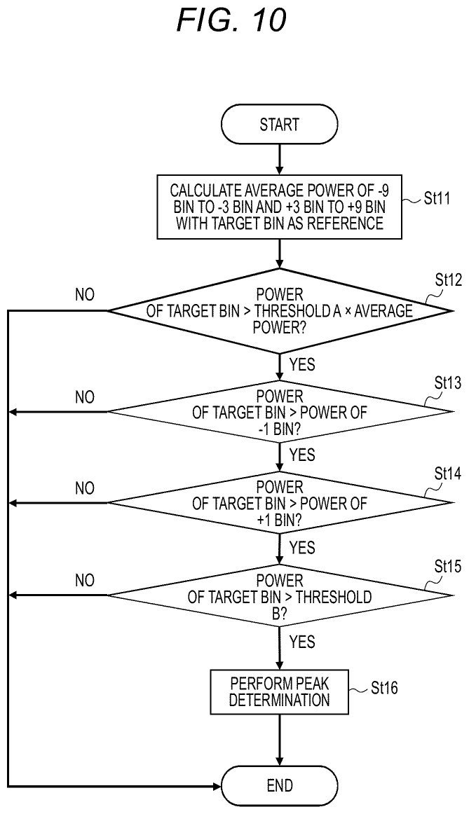

In FIG. 9, the processor 14 performs Fourier transform on the microphone signal from the microphone MIC1 to convert the microphone signal in the time domain into the microphone signal in the frequency domain (SU). As the microphone signal in the frequency domain, for example, a signal from 100 Hz to 2500 Hz is assumed to be obtained. The processor 14 detects the first peak frequency at which the power of the microphone signal Mc1 obtained for each bin of the microphone signal Mc1 is the maximum value based on the frequency characteristic of the microphone signal (for example, the microphone signal Mc1 shown in FIG. 5) in the frequency domain obtained by the conversion in step St1 (St2). Here, the bin indicates a frequency band (for example, a 10 Hz band) in a minute predetermined range. Therefore, in step St2, the processor 14 detects, for example, the first peak frequency at which the power of the microphone signal Mc1 is the peak (maximum value) for each bin of 2400 Hz from 100 to 2500 Hz (that is, a total of 240 bins when one bin is formed every 10 Hz band). Details of step St2 will be described later with reference to FIG. 10.

The processor 14 converts the speaker signal in the time domain into the speaker signal Sp1 in the frequency domain by performing Fourier transform on the speaker signal before being input to the speaker SPK1 (St3). It is assumed that the frequency domain is, for example, 100 to 2500 Hz. The processor 14 detects the second peak frequency at which the power of the speaker signal Sp1 obtained for each bin of the speaker signal Sp1 is the maximum value based on the frequency characteristic of the speaker signal (for example, the speaker signal Sp1 shown in FIG. 5) in the frequency domain obtained by the conversion in step St3 (St4). Therefore, in step St4, the processor 14 detects, for example, the second peak frequency at which the power of the speaker signal Sp1 is the peak (maximum value) for each bin of 2400 Hz from 100 to 2500 Hz (that is, a total of 240 bins when one bin is formed every 10 Hz band). Details of step St4 will be described later with reference to FIG. 10.

Based on detection results of steps St2 and St4, the processor 14 determines whether the first peak frequency (for example, f1 and f2 shown in FIG. 5) detected in step St2 and the second peak frequency (for example, f3 and f4 shown in FIG. 5) detected in step St4 match each other, and whether the time for which the peaks match each other continues for the predetermined time (for example, 100 milliseconds) or more (St5). When the first peak frequency and the second peak frequency match each other and the time for which the peaks match each other is not continuous for the predetermined time (for example, 100 milliseconds) or more (NO in St5), the audio feedback does not occur, and thus the processing of the processor 14 shown in FIG. 9 is ended.

On the other hand, when the processor 14 determines that the first peak frequency and the second peak frequency match each other and the time for which the peaks match each other continues for the predetermined time (for example, 100 milliseconds) or more (YES in St5), the processor 14 determines that the audio feedback occurs, increments the number of times of audio feedback detection, and stores the number of times of audio feedback detection in the memory 11 (St6).

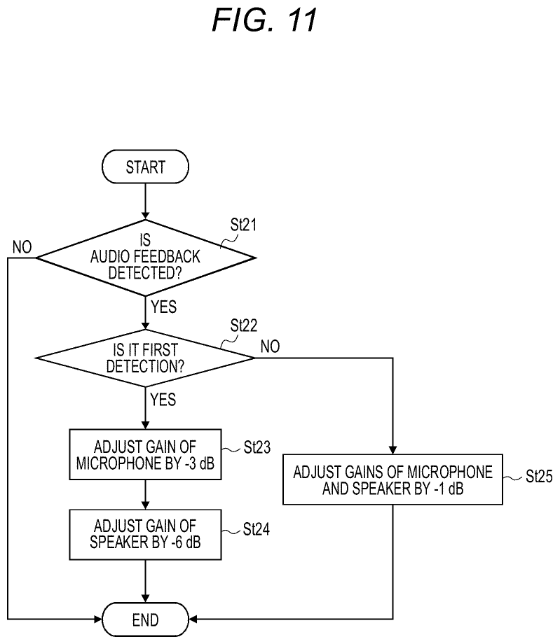

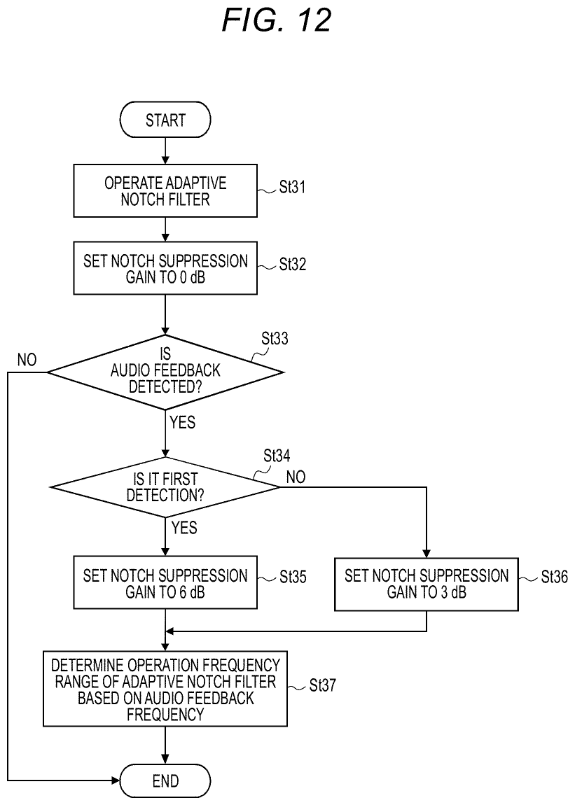

In response to the detection of the audio feedback, the processor 14 adjusts the first gain by which the microphone signal is multiplied in order to suppress the power (level) of the microphone signal before being input to the web conference application 142 to be lower than the current value (St7), and adjusts the second gain by which the speaker signal is multiplied in order to suppress the power (level) of the speaker signal before being input to the speaker SPK1 to be lower than the current value (St7). Details of step St7 will be described later with reference to FIGS. 11 and 12.

The processor 14 suppresses the power (level) of the microphone signal before being input to the web conference application 142 using the first gain adjusted in step St7 (St8). The processor 14 suppresses the power (level) of the speaker signal before being input to the speaker SPK1 using the second gain adjusted in step St7 (St9). Based on the occurrence of an audio feedback in step St6, the processor 14 displays, on the display device 16, the display screen MSG1a (see FIG. 3) for notifying the occurrence of an audio feedback or the display screen MSG1b (see FIG. 3) for notifying that the volume of the audio signal output from the speaker SPK1 is being suppressed (St10).

Next, an operation procedure of detecting the first peak frequency and the second peak frequency by PC 10 according to the first embodiment will be described with reference to FIG. 10. FIG. 10 is a flowchart of the operation procedure example of peak determination processing as a subroutine. Each of processing shown in FIG. 10 is mainly executed by the processor 14 of the PC 10. The procedure of the detection operation of the first peak frequency will be described as an example, and can be similarly applied to the procedure of the detection operation of the second peak frequency.

In FIG. 10, the processor 14 sequentially scans a target bin (that is, a bin in which average power of the microphone signal is to be calculated) among, for example, 100 Hz to 2500 Hz, and executes each of processing of the following steps St11 to St16 for each target bin. Specifically, with the target bin as a reference, the processor 14 calculates, for example, the average power in the frequency domain of the microphone signal in each of ranges from a frequency band of −9 bin from the target bin (that is, a frequency band reduced by 9 bins from the target bin) to a frequency band of −3 bin from the target bin (that is, a frequency band reduced by 3 bins from the target bin) and from a frequency band of +3 bin from the target bin (that is, a frequency band increased by 3 bins from the target bin) to a frequency band of +9 bin from the target bin (that is, a frequency band increased by 9 bins from the target bin) (St11).

The processor 14 determines whether the power in the frequency domain of the microphone signal of the target bin is larger than a multiplication result of the average power calculated in step St11 and the threshold A read from the memory 11 (St12). When the processor 14 determines that the power in the frequency domain of the microphone signal of the target bin is smaller than the multiplication result of the average power calculated in step St11 and the threshold A read from the memory 11 (NO in St12), the processor 14 determines that the power of the target bin is not the peak, and ends the processing shown in FIG. 10 performed by the processor 14.

On the other hand, when the processor 14 determines that the power in the frequency domain of the microphone signal of the target bin is larger than the multiplication result of the average power calculated in step St11 and the threshold A read from the memory 11 (YES in St12), the processor 14 determines whether the power in the frequency domain of the microphone signal of the target bin is larger than the power in the frequency band of −1 bin from the target bin (that is, the frequency band reduced by 1 bin from the target bin) (St13). When the processor 14 determines that the power in the frequency domain of the microphone signal of the target bin is smaller than the power in the frequency band of −1 bin from the target bin (that is, the frequency band reduced by 1 bin from the target bin) (NO in St13), the processor 14 determines that the power of the target bin is not the peak, and ends the processing shown in FIG. 10 performed by the processor 14.

On the other hand, when the processor 14 determines that the power in the frequency domain of the microphone signal of the target bin is larger than the power in the frequency band of −1 bin from the target bin (that is, the frequency band reduced by 1 bin from the target bin) (YES in St13), the processor 14 determines whether the power in the frequency domain of the microphone signal of the target bin is larger than the power in the frequency band of +1 bin from the target bin (that is, the frequency band increased by 1 bin from the target bin) (St14). When the processor 14 determines that the power in the frequency domain of the microphone signal of the target bin is smaller than the power in the frequency band of +1 bin from the target bin (that is, the frequency band increased by 1 bin from the target bin) (NO in St14), the processor 14 determines that the power of the target bin is not the peak, and ends the processing shown in FIG. 10 performed by the processor 14.

On the other hand, when the processor 14 determines that the power in the frequency domain of the microphone signal of the target bin is larger than the power in the frequency band of +1 bin from the target bin (that is, the frequency band increased by 1 bin from the target bin) (YES in St14), the processor 14 determines whether the power in the frequency domain of the microphone signal of the target bin is larger than the threshold B read from the memory 11 (St15). When the processor 14 determines that the power in the frequency domain of the microphone signal of the target bin is smaller than the threshold B read from the memory 11 (NO in St15), the processor 14 determines that the power of the target bin is not the peak, and ends the processing shown in FIG. 10 performed by the processor 14.

On the other hand, when the processor 14 determines that the power in the frequency domain of the microphone signal of the target bin is larger than the threshold B read from the memory 11 (YES in St15), the processor 14 determines that the power in the frequency domain of the microphone signal of the target bin is the peak (St16). After step St16, the processing shown in FIG. 10 performed by the processor 14 is ended.

Next, the operation procedure of adjusting the first gain and the second gain by the PC 10 according to the first embodiment will be described with reference to FIGS. 11 and 12. FIG. 11 is a flowchart showing a first example of the operation procedure of gain adjustment processing as a subroutine. FIG. 12 is a flowchart of a second example of the operation procedure of the gain adjustment processing as a subroutine. In the first embodiment, the operation procedure of adjusting the first gain and the second gain is executed in accordance with any one of the flowcharts of FIGS. 11 and 12. Each of processing shown in FIGS. 11 and 12 is mainly executed by the processor 14 of the PC 10.

In FIG. 11, the processor 14 determines whether the audio feedback is detected in step St6 of FIG. 9 (St21). When the processor 14 determines that the audio feedback is not detected (NO in St21), the processing shown in FIG. 11 performed by the processor 14 is ended.

On the other hand, when the processor 14 determines that the audio feedback is detected (YES in St21), the processor 14 determines whether the number of times of audio feedback detection stored in the memory 11 is 1 (that is, whether the audio feedback detection is a first detection, that is, a detection at a first time) (St22).

When the processor 14 determines that the audio feedback detection of the first detection (YES in St22), the processor 14 adjusts, for example, the gain of the microphone MIC1 (that is, the first gain) to be reduced by about 3 dB from the current value (for example, the initial value) of the first gain (St23), and adjusts the gain of the speaker SPK1 (that is, the second gain) to be reduced by about 6 dB from the current value (for example, the initial value) (St24). An adjustment amount (decrease amount) of the first gain, which is 3 dB, and an adjustment amount (decrease amount) of the second gain, which is 6 dB, are merely examples, and the processor 14 can effectively suppress the audio feedback while suppressing interruption of the web conference by adjusting the second gain to be largely reduced than the first gain. That is, it is possible to suppress the audio feedback at an early stage by largely reducing the second gain, and it is possible to suppress the audio feedback by slightly reducing the first gain, and it is possible to suppress a situation in which the utterance of the PC 10 user is rapidly decreased and other users cannot hear the utterance of the PC 10 user.

On the other hand, when the processor 14 determines that the detection of the audio feedback is not the first detection (NO in St22), the processor 14 adjusts, for example, the gain of the microphone MIC1 (that is, the first gain) and the gain of the speaker SPK1 (that is, the second gain) to be lower than the current values of the first gain and the second gain by about 1 dB (St25).

In FIG. 12, the processor 14 operates the adaptive notch filters NF1 and NF2 (St31), and sets 0 (zero) dB as the notch suppression gain in each of the adaptive notch filters NF1 and NF2 (St32). That is, the processor 14 does not suppress the microphone signal by the adaptive notch filter NF1 and does not suppress the speaker signal by the adaptive notch filter NF2.

The processor 14 determines whether the audio feedback is detected in step St6 of FIG. 9 (St33). When the processor 14 determines that the audio feedback is not detected (NO in St33), the processing shown in FIG. 12 performed by the processor 14 is ended.

On the other hand, when the processor 14 determines that the audio feedback is detected (YES in St33), the processor 14 determines whether the number of times of audio feedback detection stored in the memory 11 is 1 (that is, whether the audio feedback detection is the first detection) (St34).

When the processor 14 determines that the audio feedback detection is the first detection (YES in St34), the processor 14 sets, for example, the notch suppression gain in each of the adaptive notch filters NF1 and NF2 to 6 dB (St35). On the other hand, when the processor 14 determines that the audio feedback detection is not the first detection (NO in St34), the processor 14 sets, for example, the notch suppression gain in each of the adaptive notch filters NF1 and NF2 to 3 dB (St36). That is, the gain adjustment processing shown in FIG. 12 is different from the gain adjustment processing shown in FIG. 11 in that the notch suppression gains in the adaptive notch filters NF1 and NF2 have the same value, but is common thereto in that in a case where the audio feedback detection is the first detection, the notch suppression gains are higher than the notch suppression gains to be set in response to the second and subsequent detections, that is, detection at second and subsequent times (in other words, even in a case where the audio feedback is detected in the second and subsequent detections, the power of the microphone signal and the speaker signal are not suppressed as much as the first detection).

After step St35 or step St36, the processor 14 determines operation frequency ranges of the adaptive notch filters NF1 and NF2 based on the audio feedback frequency of the audio feedback detected in step St6 (St37). For example, the processor 14 determines a frequency band in a predetermined range centered on the audio feedback frequency as the operation frequency ranges of the adaptive notch filters NF1 and NF2. As a result, the processor 14 can effectively suppress the microphone signal and the speaker signal in the operation frequency ranges set in step St37, and thus can suppress the occurrence of an audio feedback.

As described above, in the first embodiment, the PC 10 that performs audio communication via the web conference application 142 detects whether the audio feedback is present based on the correlation between the frequency characteristics of the microphone signal obtained by sound collection by the microphone MIC1 and the speaker signal output from the speaker SPK1. As a result, it is possible to suppress the erroneous detection of an audio feedback caused by the signal processing of the web conference application 142.

For example, as described above, it is assumed that the audio feedback detection is performed by observing characteristics (for example, peaks) about the frequency characteristics. At this time, when a special frequency characteristic is added to the audio signal input to the web conference application 142 by the signal processing of the web conference application 142 and the audio feedback detection is performed on the audio signal, when the added frequency characteristic matches or is similar to the frequency characteristic to be observed in an algorithm of the audio feedback detection, the audio feedback may be erroneously detected. In particular, it is general that business entities (corporates) providing the (a program for executing) the audio signal processing unit 141 and (a program for executing) the web conference application 142 are different from each other, and in this case, since it is unknown what kind of signal processing is used to output the audio signal from the audio signal processing unit 141 generated in the web conferencing application 142 and a cloud system connected to the web conferencing application 142, the erroneous detection described above may occur.

Specifically, the web conference application 142 has an echo cancellation function. That is, when the description is performed using the PC 10, the utterance of the PC 20 user or the PC user 30, which is collected by the other PC 20 or the PC 30 and transmitted via the network NW1, is output via the speaker SPK1 and collected by the microphone MIC1, but the utterance is removed by the echo cancellation function. As a result, although an audio quality in the web conference system 100 is improved, the audio signal after the echo cancellation is not optimal for the audio feedback detection because the frequency characteristics are corrected. The web conference application 142 further includes a mute function. When the mute function is executed, since the sound is not output from the web conference application 142, the audio feedback detection cannot be performed by audio processing in a subsequent stage of the web conference application 142.

In contrast, in the first embodiment, whether the audio feedback is present is determined after confirming that the correlation of the frequency characteristics is high (for example, peak positions match or are similar) in the audio signal before being input to the web conference application 142 and the audio signal after being output from the web conference application 142. Therefore, it is possible to suppress the erroneous detection of characteristics (for example, peaks) about the frequency characteristics caused by the influence of the signal processing of the web conference application 142 as the audio feedback. Further, the audio signal processing unit 141 can suppress the erroneous detection of an audio feedback even when the signal processing performed by the web conference application 142 is unknown.

It is preferable to check the correlation of the audio signals when determining whether the audio feedback is present as in the first embodiment, whereas the audio signal processing unit 141 may perform the audio feedback detection using at least the audio signal before being input to the web conference application 142, and may control the first gain and the second gain as described above based on the result of the audio feedback detection. Accordingly, it is possible to suppress the erroneous detection caused by the signal processing of the web conference application 142 and appropriately cope with the detected audio feedback. When the correlation of the frequency characteristics between the input and the output is not observed as described above, a method for the audio feedback detection may be based on the frequency characteristics of the audio signal as described above, or other methods may be used.

As described above, the PC 10 serving as an example of the audio feedback detection apparatus according to the first embodiment includes: the communication unit (for example, the communication interface 15) configured to communicate with one or more other terminals (for example, the PCs 20 and 30) via the network NW1; the microphone MIC1 configured to acquire the first audio signal based on an utterance of a talker (for example, the PC 10 user); the speaker SPK1 configured to output the second audio signal from the other terminals, the second audio signal being received by the communication unit and processed by the audio communication application (for example, the web conference application 142); and the audio signal processing unit 141 configured to detect whether the audio feedback is present based on the correlation between the frequency characteristic of the first audio signal input to the audio communication application and the frequency characteristic of the second audio signal input to the speaker SPK1. Further, one of the microphone MIC1 and the speaker SPK1 of the PC 10 is located on the audio feedback occurrence path PTH1, and the other of the microphone MIC1 and the speaker SPK1 of the PC 10 is located on the audio feedback non-occurrence path NPTH1.

Further, the audio feedback detector HWD serving as an example of the audio feedback detection apparatus according to the first embodiment includes: the first audio signal input unit configured to acquire the first audio signal collected by the microphone MIC1; the second audio signal input unit configured to acquire the second audio signal from the audio communication application to be output to the speaker SPK1; and the audio feedback determination unit 27 configured to determine whether the audio feedback is present based on the correlation between the frequency characteristic of the first audio signal input to the audio communication application and the frequency characteristic of the second audio signal input to the speaker SPK1. Further, one of the microphone MIC1 and the speaker SPK1 of the PC 10 is located on the audio feedback occurrence path PTH1, and the other of the microphone MIC1 and the speaker SPK1 of the PC 10 is located on the audio feedback non-occurrence path NPTH1.

Thereby, it is possible to suppress the occurrence of an audio feedback that may occur with the other audio input and output apparatus (for example, the PC 20) including the microphone and the speaker.

The audio signal processing unit 141 adjusts at least one of the first gain for suppressing the first audio signal and the second gain for suppressing the second audio signal in response to the detection of the audio feedback. Accordingly, the PC 10 can effectively suppress the occurrence of an audio feedback that may occur when the plurality of PCs 10 and 20 each including the microphone and the speaker are connected with each other at the same place (for example, the place B1) in the web conference using the web conference system 100 shown in FIG. 1.

The audio signal processing unit 141 adjusts the second gain to be larger than the first gain. Accordingly, since the power (level) of the speaker signal output from the speaker SPK1 is suppressed to be larger than the power (level) of the microphone signal obtained by being collected by the microphone MIC1, the power (level) of the speaker signal output from the speaker SPK1 and going around to the microphone MIC2 of the other PC 20 is reduced, and thus it is possible to effectively suppress the audio feedback while suppressing interruption of the web conference. That is, it is possible to suppress the audio feedback at an early stage by largely reducing the second gain, and it is possible to suppress the audio feedback by slightly reducing the first gain, and it is possible to suppress a situation in which the utterance of the PC 10 user is rapidly decreased and other users cannot hear the utterance of the PC 10 user.

The audio signal processing unit 141 sets adjustment amounts of the first gain and the second gain according to the first detection of the audio feedback to be larger than adjustment amounts of the first gain and the second gain according to the second and subsequent detections of the audio feedback. Accordingly, the PC 10 can suppress the occurrence of an audio feedback as much as possible by adjusting the gains of the microphone signal and the speaker signal to suppress the power (level) when the audio feedback is detected for the first time. Further, the gains are not adjusted as much as the first time even if the audio feedback occurs for the second and subsequent time, and the PC 10 can suppress the power (level) of the microphone signal and the speaker signal in a stepwise manner by similarly adjusting the gains of the microphone signal and the speaker signal, whereby the audio feedback in the web conference system 100 can be effectively suppressed.

The audio signal processing unit 141 determines that the audio feedback occurs when the first peak frequencies f1 and f2 at which the peaks on the frequency characteristic of the first audio signal are detected match the second peak frequencies f3 and f4 at which the peaks on the frequency characteristic of the second audio signal are detected for a predetermined time or more. In FIG. 5, f1=f3, and f2=f4. Accordingly, the PC 10 can easily and accurately detect whether the audio feedback is present based on the correlation in the frequency characteristics between the microphone signal collected by the microphone MIC1 included in the PC 10 and the speaker signal input to the speaker SPK1 included in the PC 10.

The audio signal processing unit 141 further includes the first notch filter (for example, the adaptive notch filter NF1) configured to suppress the first audio signal having a frequency in a predetermined range around a frequency at which the audio feedback is detected and the second notch filter (for example, the adaptive notch filter NF2) configured to suppress the second audio signal having the frequency in the predetermined range. Accordingly, the PC 10 can gradually reduce the occurrence of an audio feedback.

The PC 10 serving as an example of the audio feedback detection apparatus according to the first embodiment includes: the microphone MIC1 configured to acquire the first audio signal based on the utterance of the talker (for example, the PC 10 user); the communication unit (for example, the communication interface 15) configured to communicate the audio signal obtained by processing the first audio signal by the audio communication application (for example, the web conference application 142) with one or more other terminals (for example, the PCs 20 and 30) via the network NW1; the speaker SPK1 configured to output the second audio signal from the other terminals received by the communication unit and processed by the audio communication application (for example, the web conference application 142); and the audio signal processing unit 141 configured to detect whether audio feedback is present based on the first audio signal before being input to the audio communication application.

The audio feedback detector HWD serving as an example of the audio feedback detection apparatus according to the first embodiment includes: a first audio signal detection unit configured to acquire a first audio signal collected by the microphone MIC1; a second audio signal detection unit configured to acquire a second audio signal from an audio communication application to be output to the speaker SPK1; and the audio feedback detector HWD configured to determine whether audio feedback is present based on the first audio signal before being input to the audio communication application.

In this case, when the peak detection unit 22 detects the peak of the power (level) in the frequency domain in the frequency characteristic of the first audio signal (for example, the microphone signal) before being input to the audio communication application (for example, the web conference application 142), the PC 10 can detect, for example, the audio feedback when the audio feedback determination unit 27 receives the detection result of the peak detection unit 22 (see a dotted arrow in FIG. 4). In any of the other audio signal processing units 141A, 141B, and 141C, similarly, it may be determined that the audio feedback occurs based on the detection result of the peak detection unit 22. Then, based on the instruction of the audio feedback determination unit 27, the PC 10 adjusts the gain by which at least one of the microphone signal before being input to the web conference application 142 and the speaker signal before being input to the speaker SPK1 is multiplied to be reduced, and suppresses at least one of the microphone signal before being input to the web conference application 142 and the speaker signal before being input to the speaker SPK1 using the adjusted gain. As a result, the PC 10 can suppress the erroneous detection of an audio feedback caused by the signal processing of audio communication application.

Although the various embodiments are described above with reference to the drawings, it is needless to say that the present disclosure is not limited to such examples. It will be apparent to those skilled in the art that various alterations, modifications, substitutions, additions, deletions, and equivalents can be conceived within the scope of the claims, and it should be understood that such changes also belong to the technical scope of the present disclosure. Components in the above-described embodiments may be combined optionally within a range not departing from the spirit of the invention.

The present disclosure is useful as an audio feedback detection apparatus and an audio feedback detection method for suppressing occurrence of an audio feedback that may occur with another audio input and output apparatus including a microphone and a speaker.

1. An audio feedback detection apparatus comprising:
a first audio signal input unit configured to acquire a first audio signal collected by a microphone;
a second audio signal input unit configured to acquire a second audio signal from an audio communication application to be output to a speaker; and
an audio feedback determination unit configured to determine whether an audio feedback is present based on a correlation between a frequency characteristic of the first audio signal input to the audio communication application and a frequency characteristic of the second audio signal input to the speaker,
wherein one of the microphone and the speaker is located on a path in which the audio feedback occurs, and the other of the microphone and the speaker is located on a path in which the audio feedback does not occur.

2. The audio feedback detection apparatus according to claim 1, further comprising:
an audio signal processing unit comprising the audio feedback determination unit, the audio signal processing unit being configured to suppress the first audio signal and the second audio signal based on information obtained by determination of the audio feedback determination unit,
wherein the audio signal processing unit adjusts, in response to a detection of the audio feedback, at least one of a first gain for suppressing the first audio signal and a second gain for suppressing the second audio signal.

3. The audio feedback detection apparatus according to claim 2,
wherein the audio signal processing unit adjusts the second gain to be larger than the first gain.

4. The audio feedback detection apparatus according to claim 2,
wherein the audio signal processing unit sets adjustment amounts of the first gain and the second gain to be set in in response to a detection of the audio feedback at a first time to be larger than adjustment amounts of the first gain and the second gain to be set in response to detections of the audio feedback at second and subsequent times.

5. The audio feedback detection apparatus according to claim 1,
wherein the audio feedback determination unit determines that the audio feedback occurs in a case in which a first peak frequency matches a second peak frequency for a predetermined time or more, the first peak frequency at which a peak on the frequency characteristic of the first audio signal is detected, the second peak frequency at which a peak on the frequency characteristic of the second audio signal is detected.

6. The audio feedback detection apparatus according to claim 1,
wherein the audio feedback determination unit further comprises:
a first notch filter configured to suppress the first audio signal having a frequency in a predetermined range around a frequency at which the audio feedback is detected; and
a second notch filter configured to suppress the second audio signal having the frequency in the predetermined range.

7. An audio feedback detection method comprising:
acquiring a first audio signal collected by a microphone;
acquiring a second audio signal from an audio communication application to be output to a speaker; and
determining whether an audio feedback is present based on a correlation between a frequency characteristic of the first audio signal input to the audio communication application and a frequency characteristic of the second audio signal input to the speaker,
wherein one of the microphone and the speaker is located on a path in which the audio feedback occurs, and the other of the microphone and the speaker is located on a path in which the audio feedback does not occur.

8. An audio feedback detection apparatus comprising:
a first audio signal detection unit configured to acquire a first audio signal collected by a microphone;
a second audio signal detection unit configured to acquire a second audio signal from an audio communication application to be output to a speaker; and
an audio feedback determination unit configured to determine whether audio feedback is present based on the first audio signal which has not been processed by the audio communication application.

9. An audio feedback detection method comprising:
acquiring a first audio signal collected by a microphone;
acquiring a second audio signal from an audio communication application to be output to a speaker; and
determining whether audio feedback is present based on the first audio signal which has not been processed by the audio communication application.
